(19) United States
(12) Patent Application Publication
(10) Pub. No.: US 2009/0094191 A1
(43) Pub. Date: Apr. 9, 2009

(54) EXPLOITING EXECUTION FEEDBACK FOR OPTIMIZING CHOICE OF ACCESS METHODS

(75) Inventors: Surajit Chaudhuri, Redmond, WA (US); Vivek R. Narasayya, Redmond, WA (US); Ravishankar Ramamurthy, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/868,957

(22) Filed: Oct. 8, 2007

(51) Int. Cl. G06F 17/30

(52) U.S. Cl. 707/2; 707/E17.131

(57) ABSTRACT

A proactive monitoring mechanism for correcting the choice of access methods (available query plans) for a given query, based on execution feedback from the same query. The mechanism exploits bypassing predicate short-circuiting inside the database server's predicate evaluation module to obtain expression cardinalities. The mechanism can also modify a plan to obtain expression cardinalities. These techniques are used judiciously by the query optimizer and/or a database administrator (DBA) so that the execution overheads are within acceptable limits.

### BACKGROUND

In conventional database systems including most of the commercial data base systems, the way a query execution plan is chosen is more or less in a static manner. When a query is received, a query optimizer evaluates the cost of different execution plans that can be used for evaluating the query and returns the best plan for the query. However, the selected plan may not always be the best, and thus, administrators may need to manually tune the optimizer to make better plan selections based on a given query.

Using feedback from query execution to improve query plans has been proposed conventionally where the feedback consists of recording the number of rows (cardinality) produced by each operator in the execution plan. This feedback is stored in a feedback cache, which is consulted by the query optimizer in conjunction with database statistics when optimizing a query. Thus, feedback obtained from one query can be used by the optimizer when optimizing a different query. Such a framework also requires no changes to the physical operators (besides counting the results) and is thus non-intrusive. This framework for execution feedback is referred to as passive monitoring.

Despite the aforesaid virtues of passive monitoring, once executed, most systems today do not adequately leverage the observations made during the execution. Relying on passive monitoring for gathering feedback can cause the query execution plan to remain stuck with a suboptimal choice of access methods used in the query plans, regardless of how many times the query executes. Intuitively, a reason why passive monitoring cannot help correct the optimizer's selection of access methods, in many cases, is because key cardinality information that is necessary to make the correction are simply not available. This lack of availability, in turn, is tied to the fact that passive monitoring restricts the collection of cardinality strictly at the output of the operators without any additional changes to the operators themselves.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed mechanisms facilitate the observation of actual expressions that exist during runtime of a particular query plan and use this information to improve future executions of the same query. This feedback framework proactively monitors expression cardinalities and feeds this information back to the optimizer thereby improving the ability of the optimizer to correct a suboptimal choice of access methods. These techniques can be implemented with low overhead while significantly improving the quality of access method plans.

The mechanisms modify the current plan “in a small way” so as to proactively monitor additional cardinality information at low overhead. This functionality can be used only when there is evidence indicating that the current plan could be significantly improved. For example, a database administrator (DBA) can turn on this functionality for a query when a problem is suspected. Alternatively, the query optimizer itself can identify that a query could benefit from additional cardinality information, and thus, enable proactive monitoring.

The mechanisms help gather additional cardinality information (over and beyond those achievable by passive monitoring) at low overhead as part of query execution. The triggering evidence for deciding when to obtain cardinality of an expression is described.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for processing a query.

FIG. 2 illustrates a query processing system in accordance with the disclosed architecture.

FIG. 3 illustrates an alternative system for using execution information as feedback for the selection of an access method.

FIG. 4 illustrates a lattice for describing the refining bounds based on feedback.

FIG. 5 illustrates an exemplary query optimization and execution steps of an algorithm for proactive monitoring.

FIG. 6 illustrates a method of processing a query using feedback of execution information.

FIG. 7 illustrates a method of utilizing proactive monitoring.

FIG. 8 illustrates a method of sampling to reduce the cost of computing cardinalities of desired expressions.

FIG. 9 illustrates a method of modifying a query plan using index intersections.

FIG. 10 illustrates a method of selecting cardinalities to monitor.

FIG. 11 illustrates a method of processing a multi-table query.

FIG. 12 illustrates a block diagram of a computing system operable to execute proactive monitoring in accordance with the disclosed architecture.

### DETAILED DESCRIPTION

The disclosed architecture complements conventional passive monitoring systems by optionally enabling a proactive monitoring system for correcting the choice of access methods (available query plans) for a given query, based on execution feedback from the same query.

A first disclosed mechanism for proactive monitoring exploits bypassing predicate short-circuiting inside the database server's predicate evaluation module to obtain expression cardinalities. A predicate is an expression that evaluates to either true or false or is an operator or function that returns a Boolean true or false. This technique applies both to Table Scan plans as well as index-based plans. A second disclosed technique introduces the concept of plan modification to obtain expression cardinalities, and is applicable to index-based plans. These techniques are used judiciously by the query optimizer and/or a database administrator (DBA) so that the execution overheads are within acceptable limits.

In one implementation, a relational query processing infrastructure can be adapted to support proactive monitoring.

The proactive monitoring mechanisms described herein can be alternatives for judicious use by the query optimizer (or a DBA) to correct errors that cannot be corrected by passive monitoring alone.

Queries can include selections predicates with the restriction that the selections on a table are a conjunction of predicates. With respect to an optimizer search space for access methods, each table can have a set of non-clustered indexes defined on it. The indexes may be single or multi-column. It is assumed that the space of query plans considered by the query optimizer for access methods for a given table include Table Scan, Index Seek, and pairwise Index Intersection. These are illustrated using the following example.

Consider a query with four predicates on a table: A>10 and B=20 and C<30 and D=40 and three indexes A, B and C exist in the table. A Table Scan access method is either a scan of a heap or a clustered index. The predicates on the table are evaluated in a Filter node. For the Index Seek access method, a range in a single non-clustered index is scanned, and the qualifying record IDs (RIDs) are used to fetch the corresponding rows from the table. The range scan results in sequential input/output (I/O), whereas the fetches from the table are random accesses. Thus, the cost of an Index Seek is often dominated by the fetch cost. The residual predicates, if any, are applied using a Filter operation. For an Index Intersection, ranges from two non-clustered indexes are scanned, and the resulting RIDs are intersected. The RIDs that survive the intersection are used to fetch the corresponding rows from the table.

In this description, up to two indexes can be intersected. The techniques can also be extended to the case of multiple intersections. Index Seek and Index Intersection access methods are referred to collectively herein as index plans.

The query optimizer uses a cost model to compare different execution plans for a given query. This cost model is a function of the cardinality of sub-expressions of the query. It is assumed that the errors in the cost model arise only due to inaccuracies in cardinality estimation, and not the cost model itself. Thus, by definition, the plan obtained when all sub-expression cardinalities are exact (or accurate) is the optimal plan for the query.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

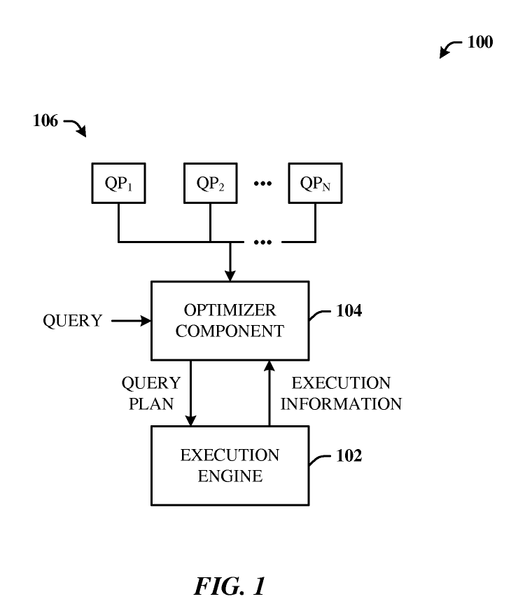

Referring initially to the drawings, FIG. 1 illustrates a computer-implemented system 100 for processing a query. The system 100 includes an execution engine 102 for executing a query plan selected for processing a query. The engine generates execution information related to the query plan during execution of the plan. An optimizer component 104 for selecting and processing the query plan from a set 106 of query plans (denoted QP₁,QP₂, . . . ,QP_{N}) based on the execution information. The plans processed by the execution engine 102 as access methods to data tables include Table Scan, Index Seek, and Index Intersection, for example.

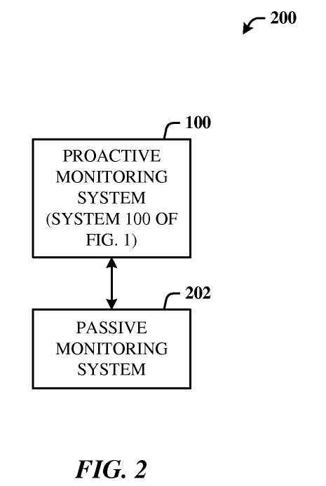

FIG. 2 illustrates a query processing system 200 in accordance with the disclosed architecture. The system 200 includes a conventional passive monitoring system 202 that uses feedback from query execution to improve query plans. The feedback consists of recording the number of rows (the cardinality) produced by each operator in the execution plan. This feedback information is stored in a feedback cache, which is consulted by the query optimizer in conjunction with database statistics when optimizing a query. Thus, feedback obtained from one query can be used by the optimizer when optimizing a different query. Such a framework also requires no changes to the physical operators (besides counting the results) and is thus non-intrusive.

The system 200 also includes the system 100 of FIG. 1 as a proactive monitoring system which complements the passive monitoring system 202. Portions of the system 100 can overlap with entities of the passive monitoring system 202, such as the execution engine, feedback cache, etc.

As previously indicated, the system 200 provides an execution feedback framework that assists in correcting the choice of access methods for a given query based on execution feedback from the same query. The current plan can be modified “in a small way” so as to proactively monitor additional cardinality information at low overhead. This added functionality is used only when there is evidence to believe that the current plan could be significantly improved. For example, the DBA can manually turn on this functionality for a query or alternatively, the query optimizer can identify that a query could benefit from additional cardinality information, and decide to turn on proactive monitoring.

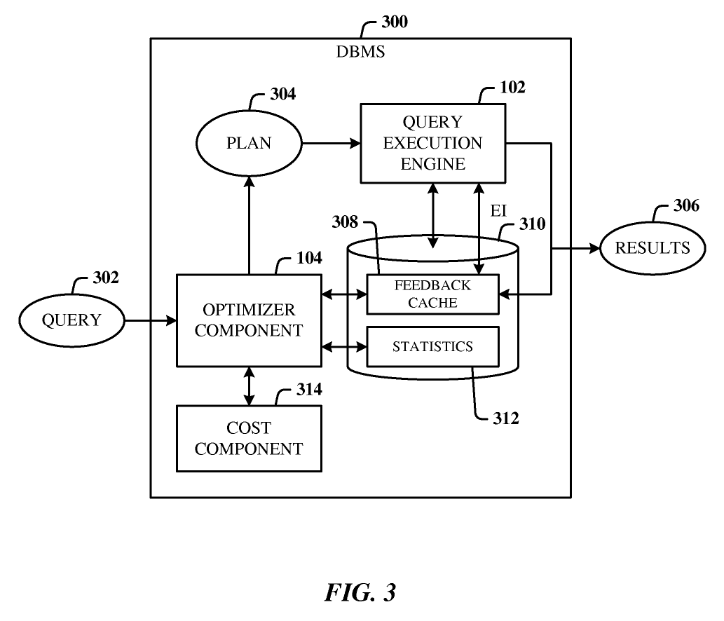

FIG. 3 illustrates an alternative system for using execution information as feedback for the selection of an access method. The optimizer component 104 (e.g., a query optimizer), as part of a database management system (DBMS) 300, receives a query 302, and selects a query plan 304 based on the query 302. The plan 304 is sent to the query execution engine 102 where execution information (EI) and results 306 are generated as part of the execution process. The results 306 can be output and also stored in a feedback cache 308 for another iteration of processing. Similarly, the EI can be stored in the feedback cache 308, which can be utilized by the optimizer component 104 for selecting a new plan or modifying the current plan 304 for the same query 302. The DBMS 300 can also include a datastore 310 for accommodating the feedback cache 308 and statistics 312 generated from query processing.

The system 300 can also include a cost component 314 that interfaces to the optimizer component 104 to analyze and provide cost information as to the benefit of using the EI in terms of at least overhead.

When the query 302 executes, feedback is collected in the form of (expression, cardinality) pairs from the output of each operator in the current query execution plan 304. An expression is the logical expression corresponding to the physical operator in the plan. For example, for the query with four predicates described above, if a Table Scan operator is used, the expression corresponding to the Filter operator is: (A>10 and B=20 and C<30 and D=40). During query optimization, when the optimizer component 104 requests the cardinality of a given expression, the optimizer 104 looks up the feedback cache 308 and uses the cardinality, if available. Otherwise, the optimizer component 104 falls back to a default mode of estimating the expression cardinality from the available database statistics 312. The default mode can be passive monitoring or cardinality information derived from histograms, for example.

Two characteristics of a feedback-based query optimizer include non-intrusiveness and robustness. With respect to non-intrusiveness, the overhead imposed on the execution of the current plan for the purposes of obtaining feedback is desired to be small. Informally, robustness means that the query does not “get stuck” with a suboptimal plan indefinitely, since the cardinalities that are available from execution are dependent on the current plan itself. Note that if the robustness property holds regardless of the current plan, this implies that the query will eventually converge to the optimal plan.

For a given query, there are a set of relevant expressions for the choice of access methods. These are the expressions whose cardinalities are used by the optimizer for computing the cost of an access method plan for the query. The subset of relevant expressions for which actual cardinality is available from the query's execution is a function of the current execution plan, and passive monitoring obtains actual cardinality for expressions corresponding to output of an operator. Feedback from passive monitoring can help the query optimizer pick a different plan for the same query. For example, if the predicate is A>10 and an Index Seek plan on A is used in the current plan, the cardinality of A>10 can be obtained from execution, which is the number of rows to be fetched from the table. If the cost of the Index Seek plan with the actual cardinality (obtained from feedback) is greater than the cost of Table Scan, then when the query is optimized the next time, the optimizer will find the Table Scan plan to be cheaper.

While passive monitoring can be useful and incurs low overhead, it can be seen that there are plans where passive monitoring cannot obtain additional cardinalities from execution feedback. This can lead to a situation where the query plan does not improve regardless of how many times the query is executed. One example of this is when the current plan is a Table Scan plan. For example, suppose A intersection B is lower in cost than the Table Scan if accurate cardinalities were available, but higher in cost according to the optimizer's current estimates (e.g., this can happen if the predicates on A and B are negatively correlated). To determine that A intersection B is lower in cost, the optimizer receives the actual cardinality of the expression (A>10 and B=20). However, the only cardinality available from executing a Table Scan plan is that of all predicates combined; in this example, it is the cardinality of (A>10 and B=20 and C<30 and D=40).

The above observation suggests that an approach that proactively obtains additional cardinalities can improve the robustness of the system to the current plan. Lightweight mechanisms are employed to make proactive monitoring non-intrusive.

At least two aspects to proactive monitoring include the mechanisms for proactive monitoring and the choice of expressions for which cardinalities are to be obtained proactively for a given query. For the first aspect, a low overhead mechanisms is presented that can obtain additional expression cardinalities from the current plan. Additional cardinalities can be obtained by making small plan modifications. Plan modifications are used judiciously by the query optimizer.

Relying exclusively on passive monitoring to obtain relevant expression cardinalities can result in situations where the plan for a query may not improve regardless of how many times that query executes. Disclosed are techniques for proactive monitoring of expressions cardinalities that are relevant for choice of access methods for a given query. These techniques assume as input a set of expressions for which actual cardinalities are desired, and a given query plan—the current plan for the query.

Consider a query with four predicates on a table: A>10 and B=20 and C<30 and D=40 and a current plan that is a Table Scan. Examining the output of a Filter operator (as passive monitoring does), only the cardinality for the expression (A>10 and B=20 and C<30 and D=40) is obtained from the execution of the current plan. Assume that the predicate evaluator inside the Filter operator for the plan evaluates the predicates in the order given above. For a set of conjunctive predicates, the predicate evaluator typically resorts to predicate short-circuiting for efficiency. In this example, for a particular row, if the predicate (A>10) evaluates to FALSE, then the remaining predicates are not evaluated to save the cost of unnecessary predicate evaluation.

Note however, by altering the predicate evaluator code and avoiding the short-circuiting optimization, a much larger set of expression cardinalities can be obtained. Since (A>10) is evaluated for every row, the cardinality of that expression can be obtained accurately. If bypassing predicate short-circuiting for the first two predicates only, then note that the cardinalities for both expressions (A>10), (B=20) become available. This implies that the cardinality of (A>10 and B=20) can also be computed. In general, if bypassing predicate short-circuiting for the first k predicates, then the cardinalities for each of the individual k expressions or any subset of the k predicates can also be computed.

The above technique is general in the sense that it can be applied to any Filter operator where a set of conjunctive predicates is evaluated. For example, this means it can be applied in the Filter operator in the Index Seek plan as well. Note however, that unlike the Filter in the Table Scan plan, the expression cardinalities obtained are conditioned on the predicate that is applied in the Index Seek (in this example A>10). Thus, using this technique cardinalities such as (A>10 and B=20), (A>10 and C<30), etc., can be obtained, but not (B=20 and C<30), for example.

There are two overheads incurred with this approach: a cost of evaluating predicates that would otherwise not be evaluated (this cost scales linearly with the number of predicates) and a cost of counting for each desired expression cardinality (this cost scales linearly with the number of expression cardinalities that are requested to count. For example, if there are indexes on A, B and C, and consider Index Seek and pairwise Index Intersection plans, cardinalities can be computed for the following relevant expressions: (A>10), (B=20), (C<30), (A>10 and B=20), (A>10 and C<30), and (B=20 and C<30). Note also, that if a larger search space of access methods are considered by the optimizer (e.g., more than pairwise index intersections), then the set of relevant expression cardinalities that may be requested can grow exponentially with the number of predicates in the worst-case.

Finally, the Filter expression can contain expensive predicates (such as those that apply a user defined function (udf)). Note that if the udf is not indexed, then no overhead is incurred since only cardinalities of expressions that can affect choice of access methods are computed. Even when the udf is indexed the optimizer may choose not to monitor the expression cardinality for the udf. Observe that the optimizers typically order predicate evaluation so that the expensive predicates are evaluated at the end, after the simpler predicates are evaluated. Thus, in such cases, it is straightforward to retain the normal short-circuiting logic and not evaluate the udf unnecessarily, while still avoiding short-circuiting for the simpler predicates, thereby obtaining expression cardinalities of the simpler predicates.

When the number of predicates is small, it can be observed that the overheads of computing expression cardinalities using the above technique are negligible. However, for a large number of predicates and requested expression cardinalities, this overhead can quickly become significant. Two techniques are presented below for reducing the cost of computing cardinalities of desired expressions. When one or both of these techniques are applied, the observed overhead can be <1% even for queries with several predicates.

The problem of counting the cardinality of an expression such as (A<10) can be done accurately using uniform random sampling. Thus, given a sampling fraction p (chosen based on overhead constraints), short-circuiting is disabled on any given row with a probability p. Note that Bernoulli sampling can be used where each row is given equal likelihood of being chosen independently from any other row. Thus, if the total number of rows in the input to the Filter is N, then the expected number of rows for which predicate short-circuiting is disabled is N.p rows. Bernoulli sampling also has the advantage that it does not require buffering of the rows. Thus, this sampling method incurs no additional memory overhead.

Another observation is that only the expression cardinalities at the end of execution of the query are used. Thus, since all rows are considered, the accuracy of the resulting cardinality is not affected by the order in which the rows arrive at the Filter operator. This technique is robust to clustering effects on disk, etc.

Note that the cardinality obtained with sampling (after scaling by dividing the sampling fraction p) is an unbiased estimator of the actual cardinality. Sampling dramatically reduces the overhead of avoiding predicate short-circuiting without significantly affecting the accuracy of cardinality.

With respect to data structures for updating counters, consider the case when the number of requested expression cardinalities is large (e.g., twenty). The counters that track the requested expression cardinalities are stored in an array. When a given predicate (say A>10) is evaluated for a particular row, it is desired to know which counters could be affected by the result of the predicate evaluation. For example, consider requested expression cardinalities for the following: (A>10), (B=20), (C<30), (A>10 and B=20), (A>10 and C<30), and (B=20 and C<30). Then the counters that are affected by the result of (A>10) are: (A>10), (A>10 and B=20), (A>10 and C<30). A bit vector (one bit per counter) can be maintained for each predicate. A bit is set to one if the result of that predicate evaluation can affect the counter, and zero, otherwise. This saves the cost of scanning the entire array of counters for each row and each predicate. Using the bit vector can reduce the overheads by more than 20% compared to the obvious implementation where the array is scanned for each row and each predicate.

The technique for proactive monitoring gives the ability for the optimizer to request additional expression cardinalities from execution without modifying the current plan with additional operators. Indeed, if the current plan is Table Scan, then the optimizer has the flexibility to request any expression cardinality that may be relevant for choice of access methods.

Although the proactive monitoring technique described above does require changes to existing operator code (such as the Filter operator), the technique does not modify the current execution plan in the sense of introducing additional physical operators. Following is a proactive monitoring technique that uses plan modification by additional physical operators in order to achieve the task of obtaining the requested cardinality. A motivation for plan modification is exemplified by the following.

The following table illustrates the usefulness of feedback obtained via passive monitoring for switching from a current (suboptimal) plan to an optimal (or better) plan. Each row in the table corresponds to a possible current plan, and each column corresponds to a better plan for the query. A cell in the table is marked Yes if passive monitoring alone is sufficient to ensure that the optimizer will find the better plan; and marked No, otherwise.

| | Optimal | | |
|---|---|---|---|
| | Table | Index Seek | Index Int. |
| Current | Scan | (C) | (C × D) |
| Table Scan | Yes | No | No |
| Index Seek | Yes | No | No |
| (A) | | | |
| Index Int. | Yes | No | No |
| (A × B) | | | |

As can be seen from the table, passive monitoring is adequate to ensure that the optimizer will find the Table Scan if it is better than the current plan. This is true not only when the current plan is Table Scan (trivially true), but even for index plans. The reason is that in any index plan all the expression cardinalities needed to cost that index plan itself can be obtained from execution. For example, for an Index Seek A plan, this means the expression cardinalities for (A>10) as well as (A>10 and B=20 and C<30 and D=40) can both be obtained from executing that plan. Thus, with the feedback obtained via passive monitoring, the optimizer will be able to determine if the Table Scan plan is cheaper than the current index plan.

In contrast, when the better plan is a different Index Seek or Index Intersection, feedback obtained via passive monitoring may be insufficient to ensure that the optimizer will find the better plan. Consider the case when the current plan for the query is an Index Seek plan on A. Then the expression whose cardinality is required to obtain an accurate cost for Index Seek B is (B=20), which cannot be obtained from the Index Seek A plan. Similar arguments apply for index intersection plans as well.

Thus, suppose the current plan is Index Seek A, and query optimizer determines that the cardinality of expression (B=20) is interesting, and requests that the actual cardinality of that expression be obtained from execution. Note that passive monitoring of the current plan is not capable of obtaining this cardinality. Similarly, cardinality of expressions such as (A>10 and B=20) can be obtained but not (B=20). This is the case since the only rows input to the Filter are the ones that satisfy the index seek predicate (A>10).

In this case, several alternatives may be possible for obtaining the cardinality (B=20). One approach is to create an asynchronous background task (which is available in conventional commercial DBMSs) that executes a query to obtain this expression cardinality. Another approach could be to request creation/update of a histogram on B so that the (or a more accurate) cardinality estimation of (B=20) is possible.

Following is a novel technique for obtaining the cardinality of an expression when the current plan is an index plan, by modifying the current plan so that when the modified plan executes, the requested cardinality (or cardinalities) is available. Plan modification can be a significant step, which if not used carefully, can result in unreasonable overheads relative to the current plan. For example, one approach could be to modify the plan into a Table Scan, from which any requested cardinality can be obtained (as described above). However, in general, the cost of the Table Scan could be much higher than the cost of the current plan (Index Seek on A in the above example), and thus the overhead incurred of plan modification can be unacceptably high. Another alternative is to modify the plan to Index Seek B, from which the cardinality of the expression (B=20) can be obtained. However, the cardinality of (B=20) is unknown, and in general, could be very high. Thus the Fetch cost itself of the modified plan could be very high as well (in fact, could be worse than even Table Scan).

A technique is to modify the plan by introducing additional index intersections, where the overheads incurred by the modified plan relative to the current plan can be controlled. If the current plan is Index Seek on A, and the plan is modified to Index Intersection between A and B, then note that the cardinality of (B=20) can be obtained when the modified plan is executed. However, adding an index intersection incurs an overhead relative to the current plan. The overhead is the cost of scanning the range in Index B as well as the cost of intersecting the record IDs (RIDs) that satisfy (A>10) with the RIDs satisfying (B=20). In general, this cost can be non-trivial particularly if the number of rows satisfying (B=20) is large. However, an index intersection plan has an beneficial property. The number of RIDs that satisfy the intersection can be no greater than the number of RIDs satisfying the predicate (A>10) (and likewise (B=20)). Thus, the Fetch cost for the index intersection plan is upper-bounded by the Fetch cost of the Index Seek plan on A. In effect, this guarantees that the fetch cost is bounded (and may even decrease) although the overall cost of the intersection plan relative to the current plan can be higher (due to the increased scan and intersection costs). For index plans, the cost of the plan is often dominated by the input/output (I/O) cost of Fetching from the table. This is because scanning the index range is a sequential I/O operation, whereas Fetch from the table requires random access I/O into the table.

In order to control the overhead to the current plan, the query optimizer can invoke plan modification via additional index intersection with care. In particular, the plan modification technique is not invoked if the current plan (when costed with actual cardinalities) already has a low absolute cost. For example, suppose the current plan P is Index Seek A, and that Cost(P)<t (a pre-specified threshold). If the optimizer estimates that the cost of scanning B and RID intersection is higher than t, then the optimizer can decide not to use the plan modification step of intersecting B with A. Note that when such a pruning is used the cost of the optimal plan can be at most t units lower than the current plan's cost. Note also that the plan modification can be invoked only when there is sufficient evidence that obtaining that expression's cardinality can potentially have a significant impact on the plan. This is addressed infra.

The proactive monitoring mechanisms described above can be used to obtain a given set of relevant expression cardinalities. These range from solutions based on bypassing predicate short-circuiting during predicate evaluation to plan modification by introducing index intersection. The mechanisms described allow the query optimizer to request additional relevant expression cardinalities from execution. However, there may be many candidate expressions for which actual cardinalities are currently not available. Thus, it is desired there be evidence that obtaining an expression's cardinality has the potential to improve the access method plan. Identifying which relevant expression cardinalities are interesting to monitor for a given query is described as follows.

In picking the set of cardinalities to monitor, two guidelines can be utilized: if the uncertainty in the possible range of cardinality values an expression can take on is low then that expression cardinality is not interesting, and information obtained using feedback should be used to continuously refine the set of candidate expressions.

Upper and lower bounds can be maintained for each expression cardinality value relevant to access path selection for this query. An expression with a larger spread between the upper and lower bounds implies greater uncertainty in the estimation, and thus, the potential to significantly affect the choice of access methods and cost of the plan. When the bounds are refined, if the lower and upper bound values coincide, then the cardinality value is exact. The selection of the set of cardinality values to obtain using execution feedback are determined using these upper and lower bounds, for example, ranked by the largest difference (the spread) between the upper and lower bounds.

Note that an expression with a large spread may still not be interesting for access method choice if the lower bound is high. For example, if the selectivity at the lower bound is 0.5 and the selectivity at the upper bound is 1.0, the spread is high, but this expression is unlikely to be served by an index plan. Thus, reducing the uncertainty for this expression is not important. It can be assumed that such expressions are pruned out based on a threshold on the selectivity of the lower bound.

Following is a description for initializing and refining the bounds using execution feedback. The optimizer's selectivity estimates can be used for initializing the bounds. For example, for an expression (A>10), the optimizer can use a histogram on the column to estimate selectivity. The lower bound value for this expression can be derived by including only the buckets in the histograms that are fully covered by this predicate. The upper bound value can be derived by also adding the counts of (up to) two boundary buckets that partially overlap with the predicate. In the absence of any feedback information, these are “best estimates” for the initial bounds for the expression.

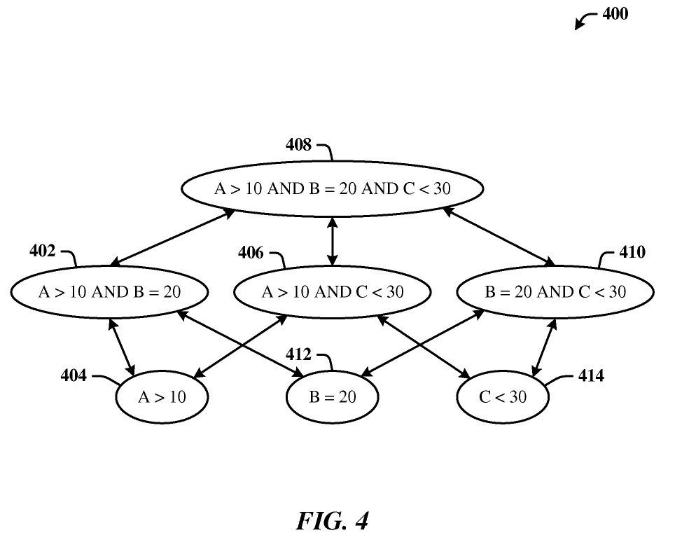

FIG. 4 illustrates a lattice 400 for describing the refining bounds based on feedback. The relationship between the set of relevant expressions that are desired for access path selection for any query can be represented using a lattice-like structure (note that not all levels of the full lattice are present). The lattice 400 shows the conjunction of predicates (A>10), (B=20) and (C>30), when the database contains single column indexes on A, B and C, and assuming a search space of Table Scan, Index Seek as well as pairwise Index Intersections.

The bounds can be propagated bi-directionally between a parent node (e.g., a node 402) and a child node (e.g., a node 404). Looking at the case of conjunctive predicates, the invariant that is maintained is that the cardinality value of any parent cannot be higher than any of its children. For instance, by obtaining the actual cardinality value of (A>10), the upper bounds of expressions (A>10 and B=20) for node 402 as well as (A>10 and C<30) for a node 406, can be immediately refined, which in turn is used to refine the upper bound of (A>10 and B=20 and C<30), the top-level node 408. Likewise, when receiving the actual cardinality of (B=20 and C<30) of a node 410, this can be used to refine the lower bound of (B=20) at node 412 and (C<30) at node 414 as well as the upper bound of (A>10 and B=20 and C<30) of node 408.

Two additional counters for every expression in the feedback cache can be employed to implement this strategy. The actual updating of counters and propagating of bounds can be governed by a policy decision.

In general, a query may access many tables, and the choice of access methods for each table can be considered. Since the optimizer decides which expression cardinalities are interesting, the framework described herein can be extended to the case of a multi-table query as well. A measure can be used that weights the spread of the selectivity for each expression by the size of the table (known from the system catalogs). This approach captures the intuition that seeking a given number of rows from a larger table is likely to incur larger random I/O access than seeking the same number of rows from a smaller table.

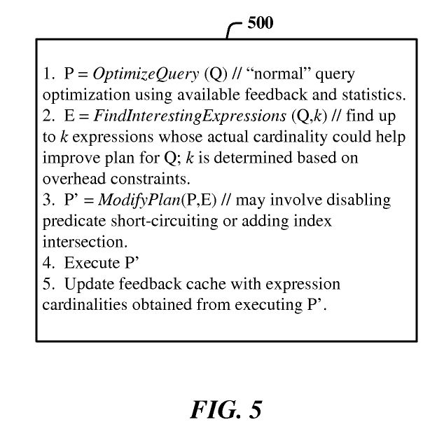

FIG. 5 illustrates an exemplary query optimization and execution steps of an algorithm 500 for proactive monitoring. The following description is a general but not all inclusive overview. During Step 1, the query optimization step, the query is first optimized as in a typical optimizer (but using available relevant feedback and/or statistics, as well). This produces an execution plan P. In Step 2, the optimizer checks if it is worthwhile to obtain actual cardinalities for certain interesting expressions. Since low overhead is a desirable criteria, in this step the optimizer picks a set E of up to k expression cardinalities to monitor during execution. Given this set E (and if it is non-empty), in Step 3, the module ModifyPlan is invoked to modify P so that the set of expressions in E is obtained when the resulting plan is executed. The ModifyPlan step invokes the modules such as bypassing predicate short-circuiting or adding index intersections, for example, ensuring that the lowest overhead technique needed to obtain that expression is used. In Step 4, the modified plan P′ is executed, and the expression cardinalities available from executing that plan are stored back into the feedback cache, as in Step 5.

For disjunctions of predicates, note that an Index Union plan is possible when each of the predicates can be Seeked using an index. Thus, the space of relevant expression cardinalities differs from the case of conjunctions. Note that predicate short-circuiting can be used for the case of disjunctions of predicates as well (the only difference is that the predicate evaluator short-circuits the evaluation as soon as a predicate evaluates to TRUE instead). The techniques for bypassing predicate short-circuiting extend to this case as well in a straightforward way. Note also that in an Index Union plan, even passive monitoring is able to give all single predicate cardinalities as well as the “all” cardinality.

A simple and correct approach for handling updates is to invalidate the cardinality of an expression if one or more columns in that expression have been updated since it was last obtained. For example, if feedback exists for (A>10) and the column A is subsequently updated, then one alternative is to discard the cardinality for (A>10). Another alternative is to track how many rows of A were updated (such a counter is often kept by the DBMS for helping trigger statistics update), and use this to maintain an upper and lower bound for the expression cardinality. In principle, such bounds can reduce the overhead needed to obtain the cardinality of the expression again due to invalidation. For example, suppose the cardinality of (A>10) prior to the update was c, and at most δrows of column A were updated; then the upper bound for cardinality on (A>10) is c+δ. If the optimizer chooses an index plan using A when given the upper bound cardinality, then A would be picked even if the new actual cardinality was obtained.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

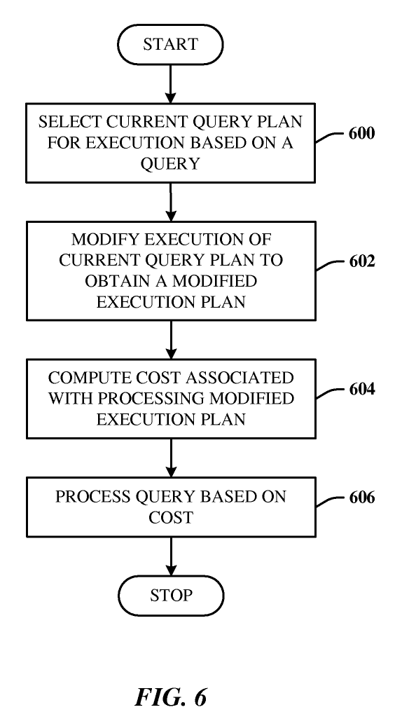

FIG. 6 illustrates a method of processing a query using feedback of execution information. At 600, a current query plan is selected for execution based on a query. At 602, execution of the current query plan is modified to obtain a modified execution plan. At 604, cost associated with processing the modified execution plan is computed. At 606, the query is automatically processed based on the cost. In other words, if the computed cost is too high, the system defaults to passive monitoring techniques which can include using statistics to improve or select a new query plan.

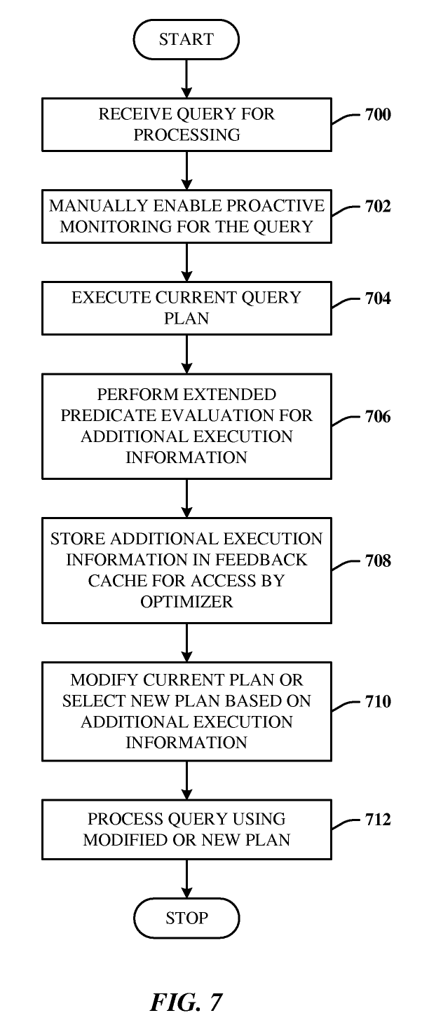

FIG. 7 illustrates a method of utilizing proactive monitoring. At 700, a query is received for processing. At 702, proactive monitoring is manually enabled by the user for this query. At 704, the selected current query plan for the query is executed. At 706, extended predicate evaluation is performed by avoiding predicate short-circuiting to receive additional execution information. At 708, the additional execution information is stored in a feedback cache, which can be accessed by the optimizer. At 710, the current plan is either modified or a new plan selected based on the additional execution information. At 712, the query is processed using the modified or new query plan.

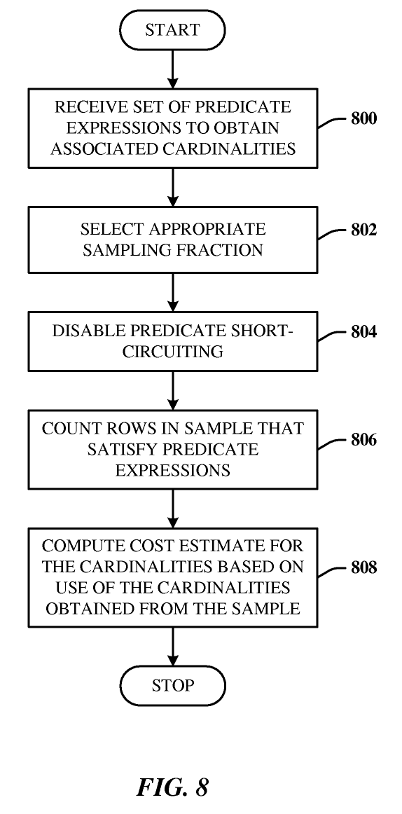

FIG. 8 illustrates a method of sampling to reduce the cost of computing cardinalities of desired expressions. At 800, a set of predicate expressions is received to obtain the associated cardinalities. At 802, an appropriate sampling fraction is selected. At 804, disable predicate short-circuiting for sample of rows. At 806, the rows in sample that satisfy predicate expressions are counted. At 808, a cost estimate for the cardinalities is computed based on use of the cardinalities obtained from the sample.

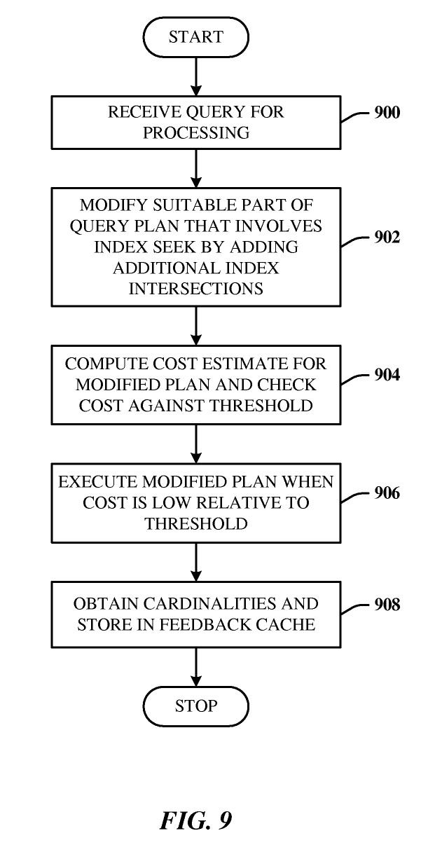

FIG. 9 illustrates a method of modifying a query plan using index intersections. At 900, a query is received for processing. At 902, a suitable part of the query plan that involves an index seek component is modified by adding additional index intersections. At 904, a cost estimate for the modified plan is computed and checked against a threshold. At 906, the modified plan is executed when the cost is low relative to the threshold. At 908, cardinalities are obtained and stored in a feedback cache.

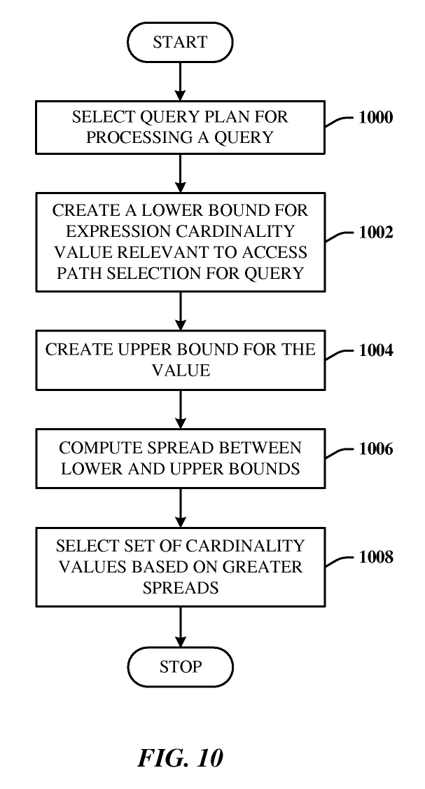

FIG. 10 illustrates a method of selecting cardinalities to monitor. At 1000, a query plan is selected for processing a query. At 1002, a lower bound is created for an expression cardinality value relevant to access path selection for the query. At 1004, an upper bound is also created for the value. At 1006, the spread between the lower and upper bounds is computed. At 1008, a set of cardinality values is selected based on the values having the greater spreads.

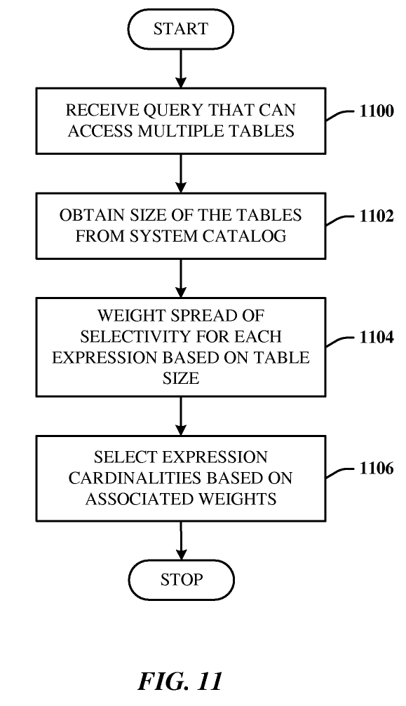

FIG. 11 illustrates a method of processing a multi-table query. At 1100, a query is received that can access multiple database tables. At 1102, the size of tables is obtained from the system catalog. At 1104, the spread of the selectivity for each expression is weighted based on the size of the table. At 1106, the expression cardinalities are selected based on the associated weights.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

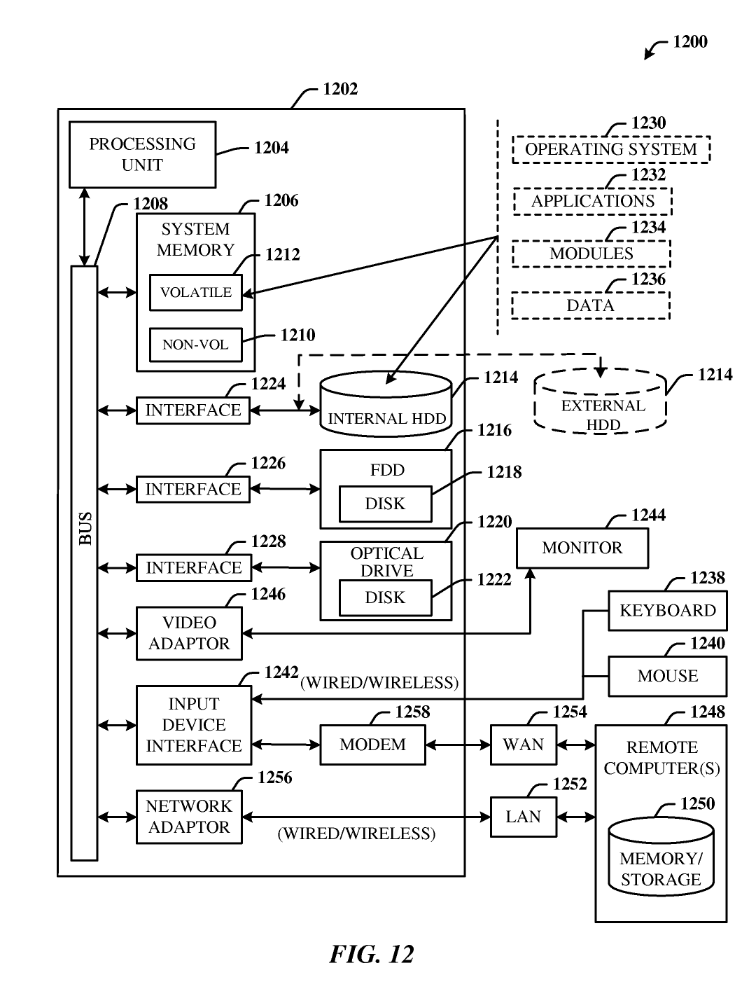

Referring now to FIG. 12, there is illustrated a block diagram of a computing system 1200 operable to execute proactive monitoring in accordance with the disclosed architecture. In order to provide additional context for various aspects thereof, FIG. 12 and the following discussion are intended to provide a brief, general description of a suitable computing system 1200 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary computing system 1200 for implementing various aspects includes a computer 1202 having a processing unit 1204, a system memory 1206 and a system bus 1208. The system bus 1208 provides an interface for system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 can include non-volatile memory (NON-VOL) 1210 and/or volatile memory 1212 (e.g., random access memory (RAM)). A basic input/output system (BIOS) can be stored in the non-volatile memory 1210 (e.g., ROM, EPROM, EEPROM, etc.), which BIOS contains the basic routines that help to transfer information between elements within the computer 1202, such as during start-up. The volatile memory 1212 can also include a high-speed RAM such as static RAM for caching data.

The computer 1202 further includes an internal hard disk drive (HDD) 1214 (e.g., EIDE, SATA), which internal HDD 1214 may also be configured for external use in a suitable chassis, a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as a DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1212, including an operating system 1230, one or more application programs 1232, other program modules 1234, and program data 1236. The operating system 1230, one or more application programs 1232, other program modules 1234, and/or program data 1236 can include the execution component 102, optimizer component 104, query plans 106, execution information, passive monitoring system 202, DBMS system 300 and entities (e.g., cost component 314, feedback cache 308), and algorithm 500, for example.

All or portions of the operating system, applications, modules, and/or data can also be cached in the volatile memory 1212. It is to be appreciated that the disclosed architecture can be implemented with various commercially available operating systems or combinations of operating systems.

A user can enter commands and information into the computer 1202 through one or more wire/wireless input devices, for example, a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces such as a parallel port, IEEE 1394 serial port, a game port, a USB port, an IR interface, etc.

A monitor 1244 or other type of display device is also connected to the system bus 1208 via an interface, such as a video adaptor 1246. In addition to the monitor 1244, a computer typically includes other peripheral output devices (not shown), such as speakers, printers, etc.

The computer 1202 may operate in a networked environment using logical connections via wire and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, is connected to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for processing a query, comprising:
an execution engine for executing a query plan selected for processing a query, the engine generating execution information related to the query plan; and
an optimizer component for selecting and processing the query plan based on the execution information.

2. The system of claim 1, further comprising a cost component for computing a cost in overhead associated with obtaining execution feedback from the query plan.

3. The system of claim 1, wherein the execution information includes expression cardinality information.

4. The system of claim 1, wherein the optimizer component automatically selects a new query plan for execution of the query based on the execution information.

5. The system of claim 1, wherein the optimizer component automatically modifies the query plan for execution of the query based on the execution information.

6. The system of claim 1, further comprising a feedback cache for storing the execution information and statistics for operating in a passive mode or a proactive mode.

7. The system of claim 1, wherein the query plan uses one or more of a table scan operator, an index seek operator or an index intersection operator.

8. The system of claim 1, wherein the execution information output by the execution engine is obtained by bypassing a predicate short-circuiting optimization to obtain additional expression cardinality information.

9. The system of claim 1, wherein a bit vector is maintained for a predicate of the query plan, the bit vector tracks a result of predicate evaluation.

10. The system of claim 1, wherein the query accesses multiple tables and the optimizer component employs a measure that weights a query plan expression according to a size of a table.

11. A computer-implemented method of processing a query, comprising:
selecting a current query plan for execution based on a query;
modifying execution of the current query plan to obtain a modified execution plan;
computing cost associated with processing the modified execution plan; and
automatically processing the query based on the cost.

12. The method of claim 11, further comprising avoiding predicate short-circuiting as part of modifying execution the current query plan to obtain an additional set of expression cardinalities.

13. The method of claim 11, further comprising employing one or more sampling techniques to reduce overhead associated with predicate short-circuiting and estimation of expression cardinalities.

14. The method of claim 11, further comprising maintaining a counter for each predicate of the current query plan to determine if requested expression cardinality information is affected by evaluation of the predicate.

15. The method of claim 11, further comprising modifying the current query plan by inserting additional index intersections.

16. The method of claim 11, further comprising selecting a new query plan based on the cost information.

17. The method of claim 11, further comprising identifying a set of relevant expression cardinalities to monitor for the current query plan.

18. The method of claim 11, further comprising maintaining upper and lower bounds for each expression cardinality value of the current query plan that is relevant to access path selection for the query.

19. The method of claim 11, further comprising selecting a cardinality value to monitor in the current query plan.

20. A computer-implemented system, comprising:
computer-implemented means for selecting a current query plan for execution based on a query;
computer-implemented means for modifying execution of the query plan to obtain a modified execution plan;
computer-implemented means for computing cost associated with processing the modified execution plan; and
computer-implemented means for processing the query based on the cost.
